(19) United States
(12) Patent Application Publication
(10) Pub. No.: US 2006/0065498 A1
(43) Pub. Date: Mar. 30, 2006

(54) Apparatus and method for bleeding motor vehicle hydraulic systems

(76) Inventor: Greg Myers, Sunbury, OH (US)

Correspondence Address: ATTN: Intellectual Property Department;Porter, Wright, Morris & Arthur LLP, 28th Floor, 41 South High Street, Columbus, OH, 43215-6194, US

(21) Appl. No.: 11/236,346

(22) Filed: Sep. 27, 2005

Related U.S. Application Data
(60) Provisional application No. 60/614,083, filed on Sep. 28, 2004.

(51) Int. Cl. B60T 11/00

(52) U.S. Cl. 188/352

(57) ABSTRACT

A device for bleeding a hydraulic system having a master cylinder connected by a hydraulic line to at least one slave cylinder having a bleed fitting valve, comprises a container holding a pressurized supply of hydraulic fluid, a valve operable to selectively release the pressurized supply of hydraulic fluid through an opening in the container, and a tube having a first end connected to the opening of the container and a second end adapted to be connected to the bleed the fitting valve. Upon operation of the valve, the hydraulic fluid exits the container through the opening, travels through the tube to the bleed fitting valve, and travels through the slave cylinder to the hydraulic line to push air out through the master cylinder and reverse bleed the hydraulic system.

### CROSS-REFERENCE TO RELATED APPLICATIONS

This application claims priority benefit of U.S. Provisional Patent Application No. 60/614,083 filed on Sep. 28, 2004, the disclosure of which is expressly incorporated herein in its entirety by reference.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to devices used for bleeding hydraulic systems, and more particularly, devices for bleeding hydraulic systems of motor vehicles.

### BACKGROUND OF THE INVENTION

It is desirable to remove all air from hydraulic lines, such as brake lines of motor vehicles, because if not removed considerable effort would be spent to first compress the air before any movement of the hydraulic fluid would require. With air in the brake lines of a motor vehicle, the brake pedal is spongy, that is, the pedal moves a considerable distance when depressed without noticeable effect because the air in the lines must first be depressed. In motor vehicles, air is typically removed from hydraulic lines leading from a master cylinder to wheel cylinders by bleeding hydraulic fluid.

The most common technique for bleeding brake lines of a motor vehicle is to attach a hose to a bleed fitting of a wheel cylinder. One person gets inside the vehicle to operate the brake pedal while a second person operates a bleed fitting valve and yells to the person inside the car to operate the brake pedal. The second person puts the end of the hose into a container, opens the valve and yells to the first person to depress the pedal. When fluid quits exiting the hose, the second person closes the valve and yells to the first person to release the brake pedal. If the second person observed air and fluid exiting the hose, the process is repeated. Each of the remaining brake lines are bled in the same manner.

As described above, this common bleeding technique requires two people. One prior solution to this problem is to provide a bleeding tool which enables one person to bleed the brake lines. One such bleeding tool includes a fitting for connection to the vehicle bleed fitting and a check valve which allows fluid to pass out of the cylinder when the brake pedal is depressed and prevents back flow toward the cylinder when the brake pedal is released. While these bleed tools permit the lines to be bled by one person, many individuals are hesitant to use this type of tool because they are unsure if all the air is out because they cannot observe the fluid coming out of the valve. Accordingly, there is a continuing need for an improved device and method for bleeding hydraulic systems of motor vehicles.

### SUMMARY OF THE INVENTION

The present invention provides a device and method for bleeding hydraulic systems of motor vehicles which overcomes at least some of the above-noted problems of the related art. According to the present invention, a device for bleeding a hydraulic system having a master cylinder connected by a hydraulic line to at least one slave cylinder having a bleed fitting valve, comprises a container holding a pressurized supply of hydraulic fluid, a valve operable to selectively release the pressurized supply of hydraulic fluid through an opening in the container, and a tube having a first end connected to the opening of the container and a second end adapted to be connected to the bleed the fitting valve. Upon operation of the valve, the hydraulic fluid exits the container through the opening, travels through the tube to the bleed fitting valve, and travels through the slave cylinder to the hydraulic line to push air out through the master cylinder.

According to another aspect of the present invention, a device for bleeding a hydraulic system having a master cylinder connected by a hydraulic line to at least one slave cylinder having a bleed fitting valve, comprises a container holding a pressurized supply of hydraulic fluid, a bladder located within the container to separate a propellant from the hydraulic fluid, a depressable valve operable to selectively release the pressurized supply of hydraulic fluid through an opening in the container upon an operator manually depressing the valve, and a tube having a first end connected to the opening of the container and a second end adapted to be connected to the bleed the fitting valve. Upon operation of the valve, the hydraulic fluid exits the container through the opening, travels through the tube to the bleed fitting valve, and travels through the slave cylinder to the hydraulic line to push air out through the master cylinder.

According to yet another aspect of the present invention, a method for bleeding a hydraulic system having a master cylinder connected by a hydraulic line to at least one slave cylinder having a bleed fitting valve, comprises the steps of obtaining a container holding a pressurized supply of hydraulic fluid, a valve operable to selectively release the pressurized supply of hydraulic fluid through an opening in the container, a tube having a first end connected to the opening of the container and a second end adapted to be connected to the bleed the fitting valve. The second end of the tube is connected to the bleed fitting valve and the container valve is operated so that the hydraulic fluid exits the container through the opening, travels through the tube to the bleed fitting valve, and travels through the slave cylinder to the hydraulic line to push air out through the master cylinder.

From the foregoing disclosure and the following more detailed description of various preferred embodiments it will be apparent to those skilled in the art that the present invention provides a significant advance in the technology of bleeding devices. Particularly significant in this regard is the potential the invention affords for providing a high quality, light weight, relatively small, low cost assembly which can be used by a single person. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a diagrammatic view of view of a hydraulic brake system of a motor vehicle;

FIG. 2 is a perspective view of a brake assembly of the hydraulic brake system of FIG. 1 having a brake bleeder valve;

FIG. 3 is a perspective view of a bleeding device according to the present invention for use on the hydraulic brake system of FIGS. 1 and 2;

FIG. 4 is a cross-sectional view of the bleeding device of FIG. 3;

FIG. 5 is a cross-sectional view of a hose attachment of the bleeding device of FIGS. 3 and 4 secured to the brake bleeder valve of the hydraulic brake system;

FIG. 6 is a cross-sectional view similar to FIG. 5 but showing an alternative hose attachment; and

FIG. 7 is a cross-sectional view similar to FIG. 4 but showing a bleeding device according to an alternative embodiment of the present invention.

It should be understood that the appended drawings are not necessarily to scale, presenting a somewhat simplified representation of various preferred features illustrative of the basic principles of the invention. The specific design features of the bleeding device as disclosed herein, including, for example, specific dimensions, orientations, and shapes of the various components. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the bleeding devices illustrated in the drawings. In general, up or upward refers to an upward direction generally within the plane of the paper in FIGS. 3 to 5 and down or downward refers to a downward direction generally within the plane of the paper in FIG. 3 to 5.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved device and method disclosed herein. The following detailed discussion of various alternative and preferred embodiments will illustrate the general principles of the invention with reference to a braking system. Other embodiments suitable for other hydraulic systems will be apparent to those skilled in the art given the benefit of this disclosure.

The following detailed discussion illustrates a bleeding device for a braking system of motor vehicle, such as an automobile, according to a preferred embodiment of the present invention. While the illustrated embodiments of the present invention are particularly adapted for use with an automobile, it is noted that the present invention can be utilized with any motor vehicle having a use for a bleeding device including motorcycles, trucks, buses, vans, recreational vehicles, earth moving equipment and the like, off road vehicles such as dune buggies and the like, air borne vehicles, and water borne vehicles.

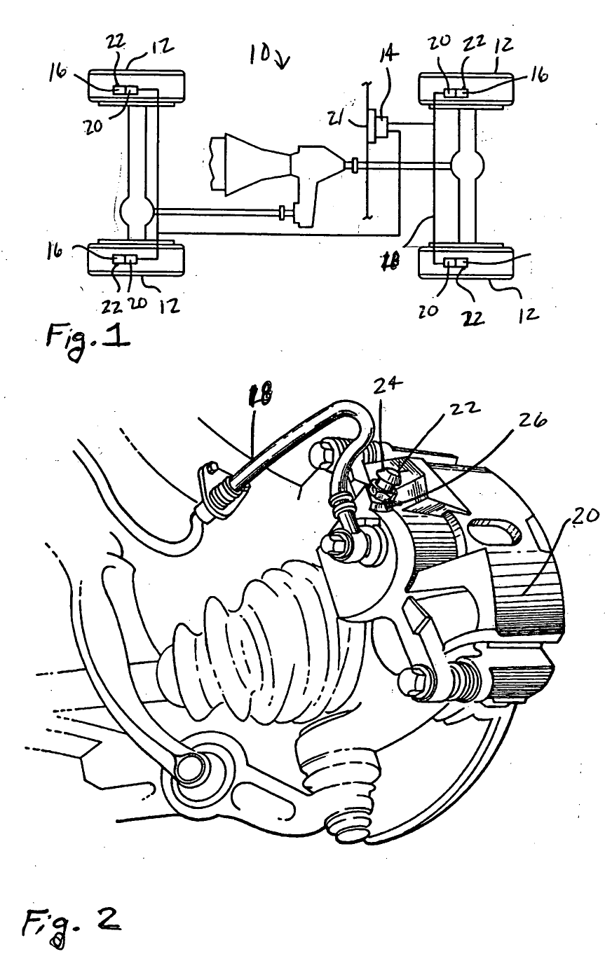

FIG. 1 illustrates a hydraulic brake system 10 of a motor vehicle having four wheels 12 such as, for example, an automobile. The hydraulic brake system 10 is designed to be activated by the operator of the motor vehicle to stop the motor vehicle by selectively placing resistance to rotation onto each of the wheels 12. The hydraulic brake system 10 includes a master cylinder 14, a plurality of slave cylinders 16, brake lines 18, and a plurality of braking mechanisms 20. The master cylinder 14 is typically mounted onto a firewall of the motor vehicle and is operated by actuation of a brake pedal by the operator of the motor vehicle. The slave cylinders 16 are located at the wheels 12 and are connected to the master cylinder 14 by the brake lines 18. Each slave cylinder is connected to a respective one of the braking mechanisms 20. Each braking mechanism 20 is typically a disc brake or a drum brake adapted to impede rotational motion of the associated wheel 12 through friction as is well known in the art.

During operation of the motor vehicle, hydraulic fluid in the master cylinder 14 is pushed from the master cylinder 14 to each slave cylinder 16 through the brake lines 18 when the master cylinder 14 is activated by the motor vehicle operator depressing the brake pedal. Activation of the slave cylinders 16 operates the braking mechanisms 20 to impede rotational motion of the wheels 12 and slow down and/or stop the motor vehicle. A brake fluid reservoir 21 associated with the master cylinder 14 ensures that only hydraulic fluid, and not air or other fluids, is permitted into the master cylinder 14, the slave cylinders 16, and the brake lines 18. When the hydraulic brake system 10 is serviced, it may become necessary to unseal the hydraulic brake system 10. Once unsealed, it becomes necessary to bleed the hydraulic brake system 10 prior to resealing and/or once resealed to ensure that all air or other fluids within the master cylinder 14, the slave cylinders 16, and the brake lines 18 has been removed.

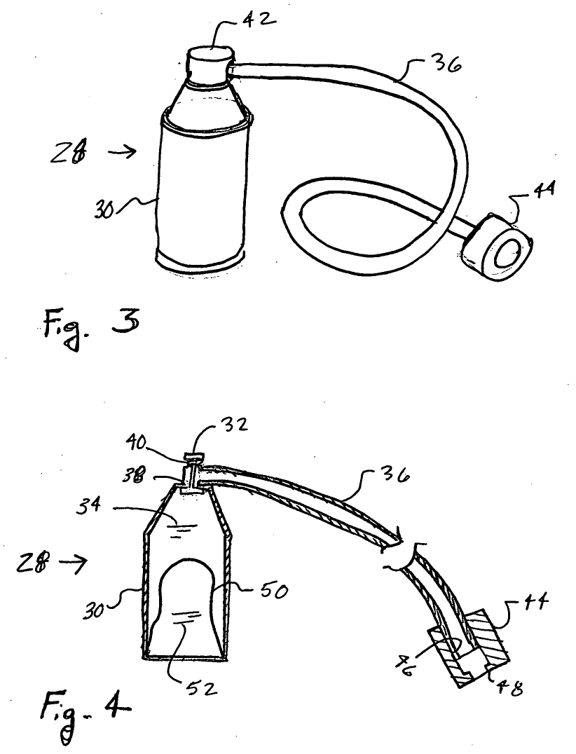

As best shown in FIG. 2, the hydraulic brake system 10 typically includes bleed fitting valves 22 located at the slave cylinders 16. Each bleed fitting valve 22 typically includes a hose-connecting member 24 and a nut member 26. The illustrated hose-connecting member 24 is frusto-conically-shaped or tapered and bulb-shaped so that a suitable hose or tube can be easily inserted thereon for the passage of hydraulic fluid into and/or out of the valve 22 through the hose. The illustrated nut member 26 is hexagonally-shaped so that a wrench can be applied to manually rotate the valve 22 to open and close the valve 22 in a known manner.

FIGS. 3 and 4 illustrate a bleeding device 28 according to the present invention. The illustrated bleeding device 28 includes a sealed container 30 for holding a pressurized supply of brake or hydraulic fluid 34, a valve 32 for selectively releasing the pressurized supply of hydraulic fluid 34, and a fluid line or tube 36 for releasably connecting the valve 32 to the fitting valves 22 of the hydraulic brake system 10. The container 30 is sized and shaped to hold a desired amount of the hydraulic fluid 34 therein and can be constructed of any suitable material. Preferably, the container 30 holds at least a suitable amount of the hydraulic fluid 34 to bleed a typical hydraulic brake system 10. It is believed that the container 30 can be formed of any suitable plastic and/or metal. The illustrated container 30 has a generally cylindrical shaped main portion with a frusto-conically shaped top portion but any other suitable shaped can alternatively be utilized.

The illustrated valve 32 is provided at an opening 38 in the top portion of the container 30. The valve 32 is movable between a closed position wherein the opening 38 is closed so that the pressurized hydraulic fluid 34 is retained in the container 30 and an open position wherein the pressurized hydraulic fluid 34 is released from the container 30 through the opening 38. The illustrated valve 32 is biased to the closed position by a spring member 40 and can be manually depressed or moved to the open position to selectively release the pressurized hydraulic fluid 34 from the container 30. It is noted that any other suitable type of valve can alternatively be utilized. The illustrated container 30 is provided with a removable cap or cover 42 which selectively covers the valve 32 to protect the valve 32 against accidental or inadvertent operation to its open position.

The illustrated tube 36 has a first end operably connected to the valve 32 so that the tube 36 is in communication with the opening 38 of the container 30. When the valve 32 is open, the pressurized hydraulic fluid 34 flows from the opening 38 and into the first end of the tube 36. The tube 36 can be permanently connected to the valve 32 or removably connected to the valve 32. The tube 36 can be formed of any suitable material such as, for example, vinyl or the like. The tube 36 is preferably constructed at least partially of a transparent material so that the passage of hydraulic fluid 34, or the lack thereof, can be visually seen through the transparent portion of the tube 36. The illustrated tube 36 is entirely constructed of transparent material.

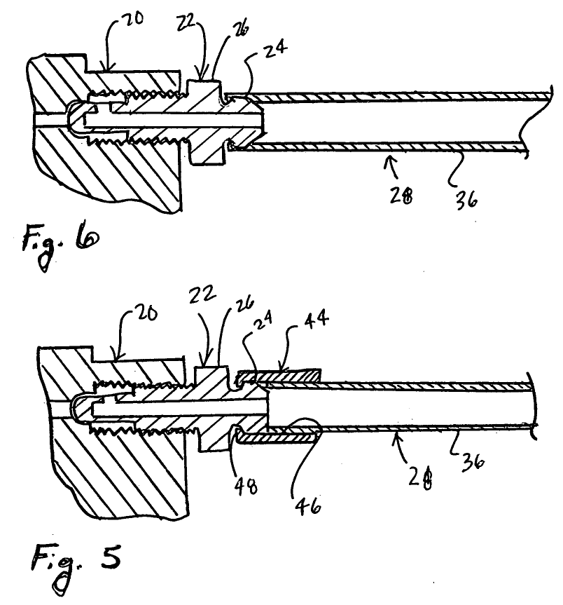

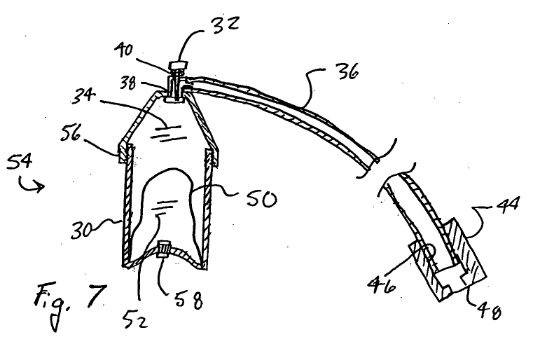

The illustrated tube 36 has a second or free end provided with a connector 44 suitably adapted so that the tube 36 can be removably connected to the bleeder fitting valves 22 of the slave cylinders 16. The illustrated connector 44 is provided with a central passage 46 with a first end sized for closely receiving the second end of the tube 36 therein and a second end sized for closely receiving the hose-connecting-member 24 of the bleeder fitting valve 22 therein to firmly secure the second end of the tube 36 to the hose-connecting member 24. As best shown in FIG. 5, the illustrated second end of the passage 46 is provided with an end wall or abutment 48 sized and shaped to engage the hose-connecting member 24 when positioned there behind to further secure the second end of the tube 32 to the fitting valve 22. The connector 44 can be formed of any suitable material but is preferably resiliently flexible to form a seal with the tube 36 and/or the fitting valve 22 and to enable the end wall 48 to be placed behind and removed from the hose-connecting member 24. As best shown in FIG. 6, the tube 36 can alternatively be constructed of a resiliently flexible material so that the tube 36 can be connected directly to the hose-connecting member 24 without the use of the connector 44.

The hydraulic fluid 34 within the container 30 is suitably pressurized so that when the valve 32 is opened, the hydraulic fluid 34 passes out the container opening 38, through the tube 36, into the bleeder fitting valve 22, and through the hydraulic brake system 10 to the master cylinder 14 as described in more detail hereinafter. As best shown in FIG. 4, the illustrated container 30 includes an internal bladder 50 which separates the hydraulic fluid 34 from a suitable propellant 52. It is noted that the hydraulic fluid 34 within the container 30 can alternatively be pressurized in any other suitable manner as long as air or other contaminants are not introduced which will affect operation of the hydraulic brake system 10.

To bleed the hydraulic brake system 10 with the bleeding device 28, the second end of the tube 36 is attached to one of the bleed fitting valves 22 (as shown in FIGS. 5 and 6). Typically, the slave cylinder 16 furthest from the master cylinder 14 is bled first. Once the tube 36 attached the fitting valve 22, the operator opens the bleeder fitting valve 22 by turning the by turning the nut member and depresses the valve 32 of the bleeding device 28 so that the pressurized hydraulic fluid 34 flows out of the container 30 through the opening 38, through the tube 36 to the bleeder fitting valve 22, through the bleeder fitting valve 22 to the slave cylinder 16, through the slave cylinder to the brake line 18, and through the brake line 18 to the master cylinder 14. Through this process, the pressurized hydraulic fluid 34 blows any air, and/or other fluids or debris, in the system 10 out through the master cylinder 14. Once bled, the container valve 32 is released to stop the flow of the hydraulic fluid 34 out of the container 30, the bleeder fitting valve 22 is closed by turning the nut member 26, and the tube 36 is removed from the bleeder fitting valve 22. The process is then repeated for each of the other bleeder fitting valves 22. Typically, moving to the next furthest slave cylinder 16 from the master cylinder 14 until all of the wheels 12 have been bled.

From the above detailed disclosure it should be appreciated that the bleeding device 28 of the present invention “reverse bleeds” the hydraulic brake system 10 utilizing the pressurized hydraulic fluid 34 to push all air up through the master cylinder 14. This is the “reverse” of the prior bleeding method of inserting hydraulic fluid into the master cylinder 14 to push air out of the fitting valves 22. This bleeding device 28 is particularly advantageous because it can be used to bleed the hydraulic brake system 10 by one person located at the fitting valve 22, includes sealed, pressurized container 30 to prevent the intake of moisture so that bleeding device 28 has a relatively long shelf-life, and is “environmentally friendly”.

It should also be appreciated from the above detailed disclosure, that the illustrated bleeding device 28 can advantageously be constructed in a manner which can be manufactured at relatively low cost so that the container 30 is disposable after expelling the hydraulic fluid 34 into the hydraulic brake system 10. It is noted, however, that the bleeding device 28 can alternatively be constructed so that it can be refilled and pressurized for continued use over and over again.

FIG. 7 illustrates a bleeding device 54 according to a second preferred embodiment of the present invention. The bleeding device 54 according to the second preferred embodiment of the present invention is substantially the same as the bleeding device according to the first embodiment described in detail above and like reference numbers are utilized to indicate like structure. The bleeding device 54 according to the second embodiment is substantially the same except that the bleeding device 54 is refillable. The illustrated top portion of the container 30 of the bleeding device 54 is removable from the main portion of the container 30 at a sealable connection 56 so that additional amounts of the hydraulic fluid 34 can be inserted into the storage cavity formed within the container 30. It is noted, however, that the container 30 can alternatively be adapted in other ways for refilling the container 30. For example, the valve 32 can be removable so that the container 30 can be refilled through the opening 38 or the container 30 can be provided with an additional opening that is selectively sealed with a plug, cap, or the like. The illustrated refillable container 30 is also provided with a propellant valve 58 so that the container 30 can be depressurized and re-pressurized during the refilling operation. The container 30 can be re-pressurized by attaching a mechanical pump, such as for example, a hand or foot operated bulb to the valve 58 to pressurized the bladder 50. It is noted that the pump can alternatively be utilized to move the hydraulic fluid 34 through the hydraulic brake system 10 during the bleeding operation

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the claims when interpreted in accordance with the benefit to which they are fairly, legally, and equitably entitled.

What is claimed is:

1. A device for bleeding a hydraulic system having a master cylinder connected by a hydraulic line to at least one slave cylinder having a bleed fitting valve, said device comprising:
a container holding a pressurized supply of hydraulic fluid;
a valve operable to selectively release the pressurized supply of hydraulic fluid through an opening in the container; and
a tube having a first end connected to the opening of the container and a second end adapted to be connected to the bleed the fitting valve so that upon operation of the valve the hydraulic fluid exits the container through the opening, travels through the tube to the bleed fitting valve, and travels through the slave cylinder to the hydraulic line to push air out through the master cylinder.

2. The device according to claim 1, wherein a bladder within the container separates a propellant from the hydraulic fluid.

3. The device according to claim 1, wherein the second end of the tube is provided with a connector adapted to cooperate with the bleed fitting valve.

4. The device according to claim 3, wherein the connector is resiliently flexible to cooperate with the bleed fitting valve.

5. The device according to claim 3, wherein the connector has an end wall which interlocks with the bleed fitting valve.

6. The device according to claim 1, wherein the second end of the tube is provided with a connector adapted to cooperate with the bleed fitting valve.

7. The device according to claim 1, wherein at least a portion of the tube is transparent.

8. The device according to claim 7, wherein the tube is entirely transparent.

9. The device according to claim 1, wherein the container is adapted to be refillable with additional supplies of the hydraulic fluid.

10. A device for bleeding a hydraulic system having a master cylinder connected by a hydraulic line to at least one slave cylinder having a bleed fitting valve, said device comprising:
a container holding a pressurized supply of hydraulic fluid;
a bladder located within the container to separate a propellant from the hydraulic fluid;
a depressable valve operable to selectively release the pressurized supply of hydraulic fluid through an opening in the container upon an operator manually depressing the valve; and
a tube having a first end connected to the opening of the container and a second end adapted to be connected to the bleed the fitting valve so that upon operation of the valve the hydraulic fluid exits the container through the opening, travels through the tube to the bleed fitting valve, and travels through the slave cylinder to the hydraulic line to push air out through the master cylinder.

11. The device according to claim 10, wherein the second end of the tube is provided with a connector adapted to cooperate with the bleed fitting valve.

12. The device according to claim 11, wherein the connector is resiliently flexible to cooperate with the bleed fitting valve.

13. The device according to claim 11, wherein the connector has an end wall which interlocks with the bleed fitting valve.

14. The device according to claim 10, wherein the second end of the tube is provided with a connector adapted to cooperate with the bleed fitting valve.

15. The device according to claim 10, wherein at least a portion of the tube is transparent.

16. The device according to claim 15, wherein the tube is entirely transparent.

17. The device according to claim 10, wherein the container is adapted to be refillable with additional supplies of the hydraulic fluid.

18. A method for bleeding a hydraulic system having a master cylinder connected by a hydraulic line to at least one slave cylinder having a bleed fitting valve, said method comprising the steps of:
obtaining a container holding a pressurized supply of hydraulic fluid, a valve operable to selectively release the pressurized supply of hydraulic fluid through an opening in the container, a tube having a first end connected to the opening of the container and a second end adapted to be connected to the bleed the fitting valve;
connecting the second end of the tube to the bleed fitting valve; and
operating the container valve so that the hydraulic fluid exits the container through the opening, travels through the tube to the bleed fitting valve, and travels through the slave cylinder to the hydraulic line to push air out through the master cylinder.

19. The method according to claim 18, wherein the step of connecting the second end of the tube to the bleed fitting valve includes placing a resiliently flexible connector of the tube over the bleed fitting valve.

20. The method according to claim 18, further comprising the step of watching the hydraulic fluid flow through the tube through a transparent portion of the tube.
